(19) United States
(12) Patent Application Publication
(10) Pub. No.: US 2023/0107250 A1
(43) Pub. Date: Apr. 6, 2023

(54) TECHNIQUES FOR SELECTIVELY RECEIVING A COMMUNICATION BASED AT LEAST IN PART ON TIMING OF A RESOURCE ALLOCATION RELATIVE TO A CLOSEST PERIODIC COMMUNICATION

(71) Applicant: QUALCOMM Incorporated, San Diego, CA (US)

(72) Inventors: Wooseok NAM, San Diego, CA (US); Hari SANKAR, San Diego, CA (US); Tao LUO, San Diego, CA (US); Peter Pui Lok ANG, San Diego, CA (US)

(21) Appl. No.: 17/818,527

(22) Filed: Aug. 9, 2022

Related U.S. Application Data
(60) Provisional application No. 63/261,999, filed on Oct. 1, 2021.

(51) Int. Cl. H04W 72/14; H04W 72/06; H04W 72/08; H04L 1/18; H04L 5/00; H04W 52/02

(52) U.S. Cl. CPC H04W 72/14; H04W 72/06; H04W 72/08; H04L 1/1812; H04L 5/0055; H04W 52/0277

(57) ABSTRACT

Various aspects of the present disclosure generally relate to wireless communication. In some aspects, a user equipment (UE) may receive a configuration of one or more periodic communications. The UE may receive an indication of a resource allocation for a communication. The UE may determine whether to receive the communication based at least in part on whether the resource allocation has resources within a threshold amount of time from a closest periodic communication of the one or more periodic communications. Numerous other aspects are described.

### CROSS-REFERENCE TO RELATED APPLICATION

This patent application claims priority to U.S. Provisional Patent Application No. 63/261,999, filed on Oct. 1, 2021, entitled “TECHNIQUES FOR SELECTIVELY RECEIVING A COMMUNICATION BASED AT LEAST IN PART ON TIMING OF A RESOURCE ALLOCATION RELATIVE TO A CLOSEST PERIODIC COMMUNICATION,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for selectively receiving a communication based at least in part on timing of a resource allocation relative to a closest periodic communication.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth, transmit power, etc.). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

These multiple access technologies have been adopted in various telecommunication standards to provide a common protocol that enables different UEs to communicate on a municipal, national, regional, or global level. New Radio (NR), which also may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency-division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation.

### SUMMARY

Some aspects described herein relate to a method of wireless communication performed by a user equipment (UE). The method may include receiving a configuration of one or more periodic communications. The method may include receiving an indication of a resource allocation for a communication. The method may include determining whether to receive the communication based at least in part on whether the resource allocation has resources within a threshold amount of time from a closest periodic communication of the one or more periodic communications.

Some aspects described herein relate to a method of wireless communication performed by a UE. The method may include receiving a configuration of one or more periodic communications. The method may include receiving an indication of a resource allocation for a communication. The method may include selectively, receiving the communication based at least in part on the resource allocation having resources within a threshold amount of time from a closest periodic communication of the one or more periodic communications, or refraining from receiving the communication based at least in part on the resource allocation having resources outside of the threshold amount of time from the closest periodic communication of the one or more periodic communications.

Some aspects described herein relate to a method of wireless communication performed by a UE. The method may include receiving a configuration of one or more periodic communications. The method may include receiving an indication of a resource allocation for a communication. The method may include selectively receiving the communication based at least in part on whether the resource allocation has resources within a threshold amount of time from a closest periodic communication of the one or more periodic communications.

Some aspects described herein relate to a method of wireless communication performed by a network node. The method may include transmitting, to a UE, a configuration of one or more periodic communications. The method may include transmitting, to the UE, an indication of a resource allocation for a communication, the resource allocation having resources within a threshold amount of time from a closest periodic communication of the one or more periodic communications.

Some aspects described herein relate to a UE for wireless communication. The UE may include a memory and one or more processors coupled to the memory. The one or more processors may be configured to receive a configuration of one or more periodic communications. The one or more processors may be configured to receive an indication of a resource allocation for a communication. The one or more processors may be configured to determine whether to receive the communication based at least in part on whether the resource allocation has resources within a threshold amount of time from a closest periodic communication of the one or more periodic communications.

Some aspects described herein relate to a UE for wireless communication. The UE may include a memory and one or more processors coupled to the memory. The one or more processors may be configured to receive a configuration of one or more periodic communications. The one or more processors may be configured to receive an indication of a resource allocation for a communication. The one or more processors may be configured to selectively, receive the communication based at least in part on the resource allocation having resources within a threshold amount of time from a closest periodic communication of the one or more periodic communications, or refrain from receiving the communication based at least in part on the resource allocation having resources outside of the threshold amount of time from the closest periodic communication of the one or more periodic communications.

Some aspects described herein relate to a UE for wireless communication. The UE may include a memory and one or more processors coupled to the memory. The one or more processors may be configured to receive a configuration of one or more periodic communications. The one or more processors may be configured to receive an indication of a resource allocation for a communication. The one or more processors may be configured to selectively receive the communication based at least in part on whether the resource allocation has resources within a threshold amount of time from a closest periodic communication of the one or more periodic communications.

Some aspects described herein relate to a network node for wireless communication. The network node may include a memory and one or more processors coupled to the memory. The one or more processors may be configured to transmit, to a UE, a configuration of one or more periodic communications. The one or more processors may be configured to transmit, to the UE, an indication of a resource allocation for a communication, the resource allocation having resources within a threshold amount of time from a closest periodic communication of the one or more periodic communications.

Some aspects described herein relate to a non-transitory computer-readable medium that stores a set of instructions for wireless communication by a UE. The set of instructions, when executed by one or more processors of the UE, may cause the UE to receive a configuration of one or more periodic communications. The set of instructions, when executed by one or more processors of the UE, may cause the UE to receive an indication of a resource allocation for a communication. The set of instructions, when executed by one or more processors of the UE, may cause the UE to determine whether to receive the communication based at least in part on whether the resource allocation has resources within a threshold amount of time from a closest periodic communication of the one or more periodic communications.

Some aspects described herein relate to a non-transitory computer-readable medium that stores a set of instructions for wireless communication by a UE. The set of instructions, when executed by one or more processors of the UE, may cause the UE to receive a configuration of one or more periodic communications. The set of instructions, when executed by one or more processors of the UE, may cause the UE to receive an indication of a resource allocation for a communication. The set of instructions, when executed by one or more processors of the UE, may cause the UE to selectively, receive the communication based at least in part on the resource allocation having resources within a threshold amount of time from a closest periodic communication of the one or more periodic communications, or refrain from receiving the communication based at least in part on the resource allocation having resources outside of the threshold amount of time from the closest periodic communication of the one or more periodic communications.

Some aspects described herein relate to a non-transitory computer-readable medium that stores a set of instructions for wireless communication by a UE. The set of instructions, when executed by one or more processors of the UE, may cause the UE to receive a configuration of one or more periodic communications. The set of instructions, when executed by one or more processors of the UE, may cause the UE to receive an indication of a resource allocation for a communication. The set of instructions, when executed by one or more processors of the UE, may cause the UE to selectively receive the communication based at least in part on whether the resource allocation has resources within a threshold amount of time from a closest periodic communication of the one or more periodic communications.

Some aspects described herein relate to a non-transitory computer-readable medium that stores a set of instructions for wireless communication by a network node. The set of instructions, when executed by one or more processors of the network node, may cause the network node to transmit, to a UE, a configuration of one or more periodic communications. The set of instructions, when executed by one or more processors of the network node, may cause the network node to transmit, to the UE, an indication of a resource allocation for a communication, the resource allocation having resources within a threshold amount of time from a closest periodic communication of the one or more periodic communications.

Some aspects described herein relate to an apparatus for wireless communication. The apparatus may include means for receiving a configuration of one or more periodic communications. The apparatus may include means for receiving an indication of a resource allocation for a communication. The apparatus may include means for determining whether to receive the communication based at least in part on whether the resource allocation has resources within a threshold amount of time from a closest periodic communication of the one or more periodic communications.

Some aspects described herein relate to an apparatus for wireless communication. The apparatus may include means for receiving a configuration of one or more periodic communications. The apparatus may include means for receiving an indication of a resource allocation for a communication. The apparatus may include means for selectively, receiving the communication based at least in part on the resource allocation having resources within a threshold amount of time from a closest periodic communication of the one or more periodic communications, or refraining from receiving the communication based at least in part on the resource allocation having resources outside of the threshold amount of time from the closest periodic communication of the one or more periodic communications.

Some aspects described herein relate to an apparatus for wireless communication. The apparatus may include means for receiving a configuration of one or more periodic communications. The apparatus may include means for receiving an indication of a resource allocation for a communication. The apparatus may include means for selectively receiving the communication based at least in part on whether the resource allocation has resources within a threshold amount of time from a closest periodic communication of the one or more periodic communications.

Some aspects described herein relate to an apparatus for wireless communication. The apparatus may include means for transmitting, to a UE, a configuration of one or more periodic communications. The apparatus may include means for transmitting, to the UE, an indication of a resource allocation for a communication, the resource allocation having resources within a threshold amount of time from a closest periodic communication of the one or more periodic communications.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example of communications in a power efficiency mode, in accordance with the present disclosure.

FIGS. 4-5 are diagrams illustrating examples associated with selectively receiving a communication based at least in part on timing of a resource allocation relative to a closest periodic communication, in accordance with the present disclosure.

FIGS. 6-9 are diagrams illustrating example processes associated with selectively receiving a communication based at least in part on timing of a resource allocation relative to a closest periodic communication, in accordance with the present disclosure.

FIGS. 10-11 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

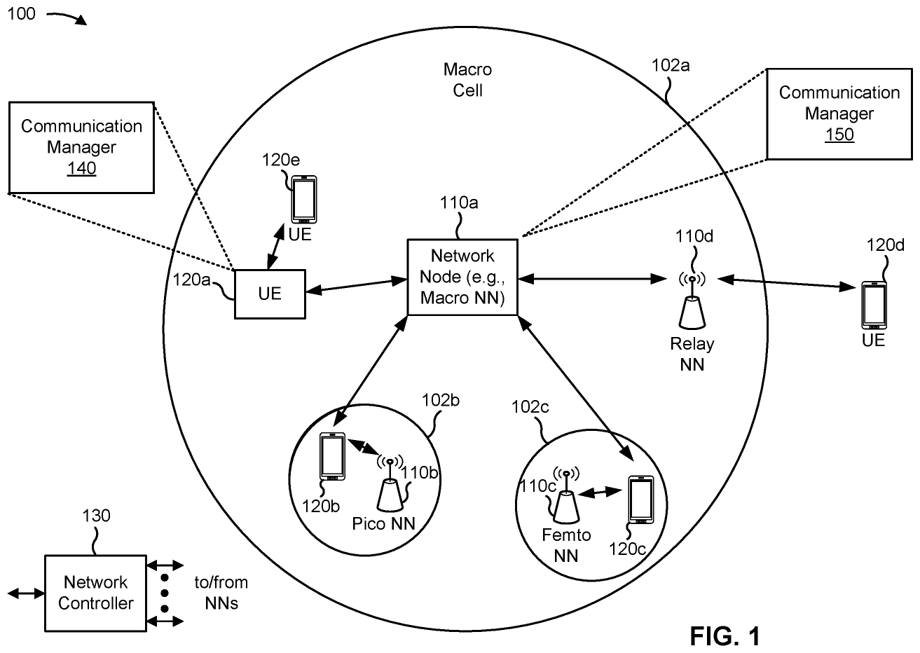

FIG. 1 is a diagram illustrating an example of a wireless network 100. The wireless network 100 may be or may include elements of a 5G (for example, NR) network or a 4G (for example, Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), or other entities. A network node 110 is an example of a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (for example, in 4G), a gNB (for example, in 5G), an access point, or a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used. A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (for example, a network node 110 or a UE 120) and send a transmission of the data to a downstream node (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay base station, a relay network node, a relay node, or a relay, among other examples.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless or wired medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any number of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz. Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With these examples in mind, unless specifically stated otherwise, the term “sub-6 GHz,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may receive a configuration of one or more periodic communications; receive an indication of a resource allocation for a communication; and determine whether to receive the communication based at least in part on whether the resource allocation has resources within a threshold amount of time from a closest periodic communication of the one or more periodic communications. Additionally, or alternatively, the communication manager 140 may perform one or more other operations described herein.

In some aspects, the UE 120 may include a communication manager 140. As described in more detail elsewhere herein, the communication manager 140 may receive a configuration of one or more periodic communications; receive an indication of a resource allocation for a communication; and selectively: receive the communication based at least in part on the resource allocation having resources within a threshold amount of time from a closest periodic communication of the one or more periodic communications, or refrain from receiving the communication based at least in part on the resource allocation having resources outside of the threshold amount of time from the closest periodic communication of the one or more periodic communications. Additionally, or alternatively, the communication manager 140 may perform one or more other operations described herein.

In some aspects, the UE 120 may include a communication manager 140. As described in more detail elsewhere herein, the communication manager 140 may receive a configuration of one or more periodic communications; receive an indication of a resource allocation for a communication; and selectively receive the communication based at least in part on whether the resource allocation has resources within a threshold amount of time from a closest periodic communication of the one or more periodic communications. Additionally, or alternatively, the communication manager 140 may perform one or more other operations described herein.

In some aspects, the network node 110 may include a communication manager 150. As described in more detail elsewhere herein, the communication manager 150 may transmit, to a UE, a configuration of one or more periodic communications; transmit, to the UE, an indication of a resource allocation for a communication, the resource allocation having resources within a threshold amount of time from a closest periodic communication of the one or more periodic communications. Additionally, or alternatively, the communication manager 150 may perform one or more other operations described herein.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, a base station, or a network equipment may be implemented in an aggregated or disaggregated architecture. For example, a base station (such as a Node B (NB), evolved NB (eNB), NR base station (BS), 5G NB, gNodeB (gNB), access point (AP), TRP, or cell), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station may be configured to utilize a radio protocol stack that is physically or logically integrated within a single RAN node (for example, within a single device or unit). A disaggregated base station may be configured to utilize a protocol stack that is physically or logically distributed among two or more units (such as one or more CUs, one or more DUs, or one or more RUs). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also may be implemented as virtual units (e.g., a virtual central unit (VCU), a virtual distributed unit (VDU), or a virtual radio unit (VRU)).

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that may be individually deployed. A disaggregated base station may include functionality implemented across two or more units at various physical locations, as well as functionality implemented for at least one unit virtually, which may enable flexibility in network design. The various units of the disaggregated base station may be configured for wired or wireless communication with at least one other unit of the disaggregated base station.

As indicated above, FIG. 1 is provided as an example. Other examples may differ from what is described with regard to FIG. 1.

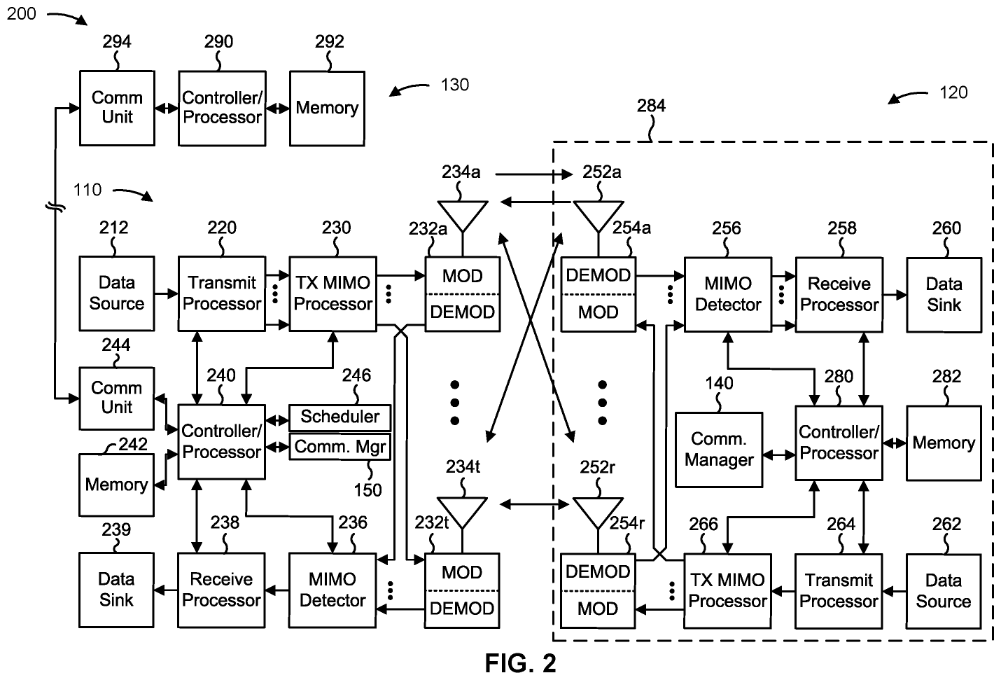

FIG. 2 is a diagram illustrating an example 200 of a network node 110 in communication with a UE 120 in a wireless network 100. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 using one or more channel quality indicators (CQIs) received from that UE 120. The network node 110 may process (for example, encode and modulate) the data for the UE 120 using the MC S(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

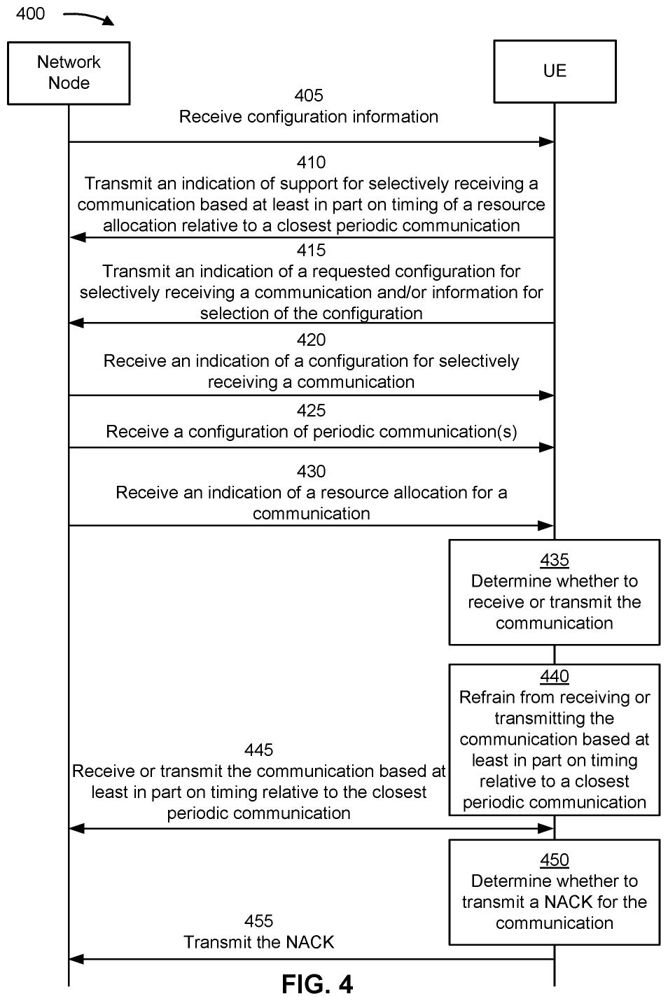

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the processes described herein (e.g., with reference to FIGS. 4-11).

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the processes described herein (e.g., with reference to FIGS. 4-11).

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network node 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

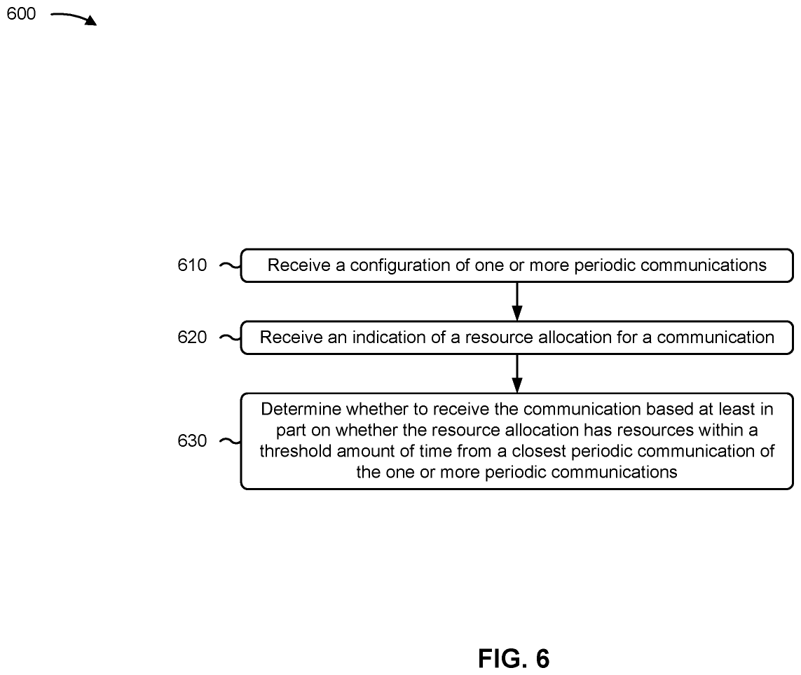

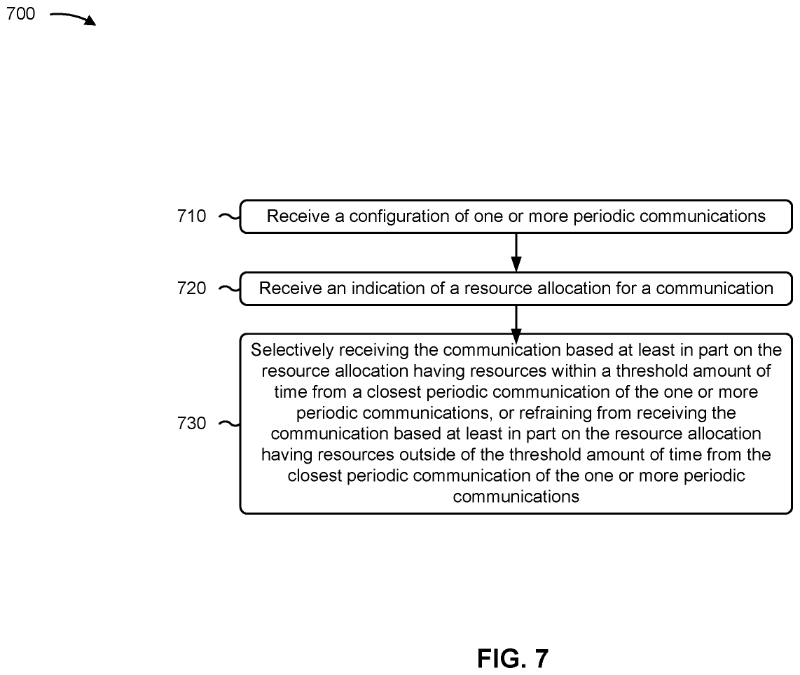

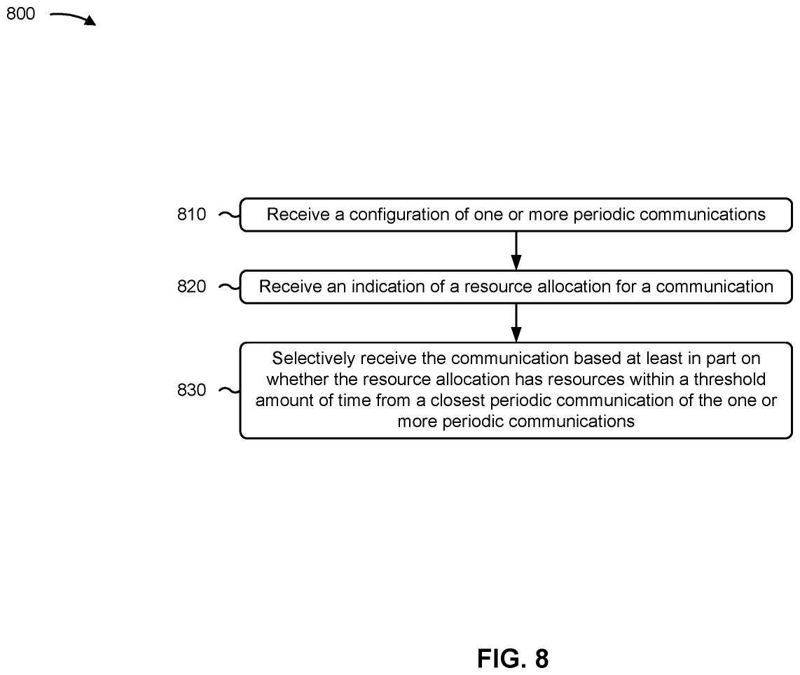

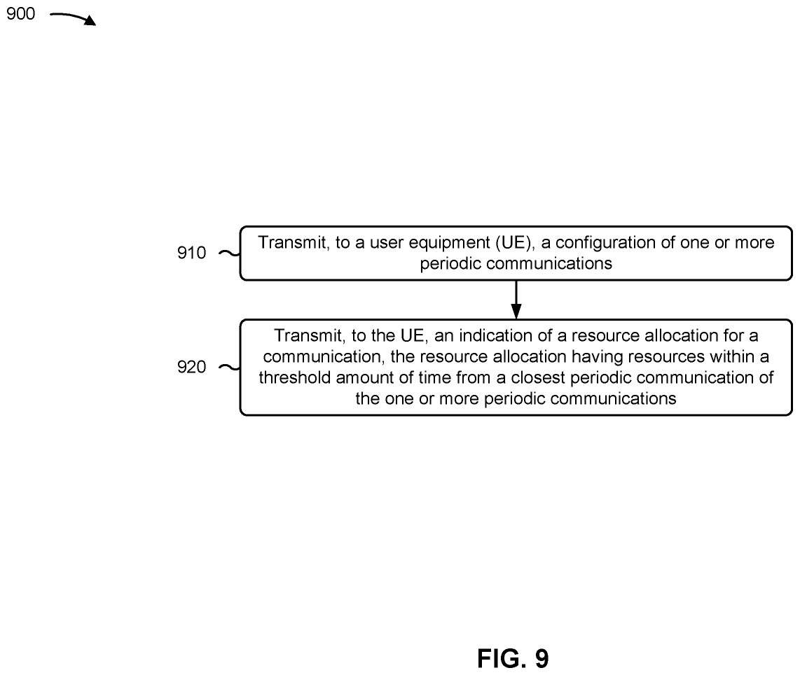

The controller/processor 240 of the network node 110, the controller/processor 280 of the UE 120, or any other component(s) of FIG. 2 may perform one or more techniques associated with selectively receiving a communication based at least in part on timing of a resource allocation relative to a closest periodic communication, as described in more detail elsewhere herein. For example, the controller/processor 240 of the network node 110, the controller/processor 280 of the UE 120, or any other component(s) (or combinations of components) of FIG. 2 may perform or direct operations of, for example, process 600 of FIG. 6, process 700 of FIG. 7, process 800 of FIG. 8, process 900 of FIG. 9, and/or other processes as described herein. The memory 242 and the memory 282 may store data and program codes for the network node 110 and the UE 120, respectively. In some examples, the memory 242 and the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 600 of FIG. 6, process 700 of FIG. 7, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, the UE includes means for receiving a configuration of one or more periodic communications; means for receiving an indication of a resource allocation for a communication; and/or means for determining whether to receive the communication based at least in part on whether the resource allocation has resources within a threshold amount of time from a closest periodic communication of the one or more periodic communications. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the UE includes means for receiving a configuration of one or more periodic communications; means for receiving an indication of a resource allocation for a communication; and/or means for selectively receiving the communication based at least in part on the resource allocation having resources within a threshold amount of time from a closest periodic communication of the one or more periodic communications, or means for refraining from receiving the communication based at least in part on the resource allocation having resources outside of the threshold amount of time from the closest periodic communication of the one or more periodic communications. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the UE includes means for receiving a configuration of one or more periodic communications; means for receiving an indication of a resource allocation for a communication; and/or means for selectively receiving the communication based at least in part on whether the resource allocation has resources within a threshold amount of time from a closest periodic communication of the one or more periodic communications. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node includes means for transmitting, to a UE, a configuration of one or more periodic communications; means for transmitting, to the UE, an indication of a resource allocation for a communication, the resource allocation having resources within a threshold amount of time from a closest periodic communication of the one or more periodic communications. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

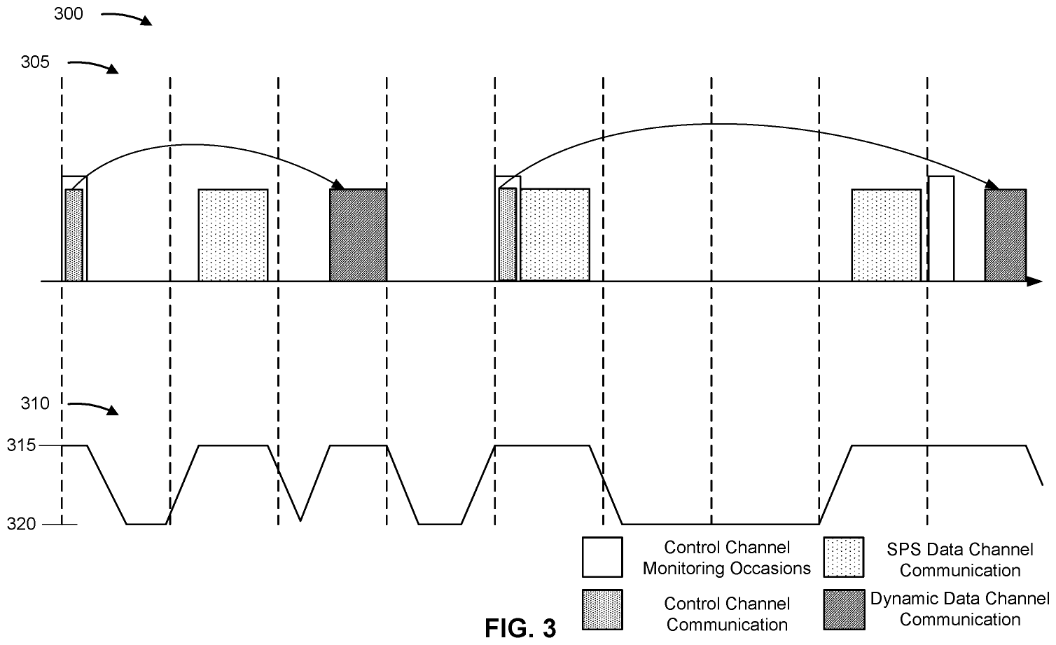

FIG. 3 is a diagram illustrating an example 300 of communications in a power efficiency mode, in accordance with the present disclosure. A first device (e.g., a UE) may be configured with a set of control channel monitoring occasions (e.g., physical downlink control channel (PDCCH) monitoring occasions or physical sidelink control channel (PSCCH) monitoring occasions) during which the first device is to monitor for a control channel communication. For example, the first device may be configured with the set of control channel monitoring occasions based at least in part on the first device being in a power saving mode, such as a discontinuous reception (DRX) mode.

To conserve power, the first device may be in a power efficiency mode in which the first device is configured to wake up for control channel monitoring occasions with an increased period length than in a standard power efficiency mode. For example, as shown in by reference number 305, the first device may be configured with a control channel monitoring occasion every fourth slot.

The first device may receive a control channel communication, within a control channel monitoring occasion, that schedules a dynamic data channel communication. Additionally, or alternatively, the first device may be configured with a semi-persistent scheduling (SPS)-based data channel communication.

As shown by reference number 310, the first device may consume different amounts of power resources based at least in part on whether the first device is in a wake-up time or a sleep time. For example, the first device may consume a first amount of power shown by reference number 315 when in a wake up time and may consume a second amount of power shown by reference number 320 when in a sleep time. Additionally, or alternatively, the first device may consume power in a ramp up time preceding a wake up time and in a ramp down time after the wake up time.

As shown in example 300, the first device may be configured in a power saving mode and/or in a power efficiency mode with an intention to conserve power resources. However, based at least in part on having data channel communications scheduled in slots during which the first device would otherwise be in a sleep mode, the first device may be required to consume power resources to wake up for reception or transmission of the data channel communications. In this way, an intended conservation of power resources may be reduced.

As indicated above, FIG. 3 is provided as an example. Other examples may differ from what is described with regard to FIG. 3.

In some aspects described herein, a first device (e.g., a UE) may be configured in a power efficiency mode associated with communicating using periodic communications having a periodicity that satisfies a threshold (e.g., with monitoring occasions that are more sparce than for a standard periodicity). For example, the power efficiency mode (e.g., a default dynamic search space set group (SSSG) mode or a power saving operation mode, among other examples) may be associated with having control channel monitoring occasions that have a periodicity that satisfies the threshold. In some aspects, the first device may not expect that a distance (e.g., in time) satisfies a threshold, where the distance is measured between a nearest control channel (e.g., PDCCH) monitoring occasion and a data channel (e.g., a physical downlink shared channel (PDSCH), a physical uplink shared channel (PUSCH), and/or a physical sidelink shared channel, among other examples) and/or communication of a signal (e.g., an aperiodic channel state information (CSI) reference signal (CSI-RS) and/or aperiodic sounding reference signals (SRSs), among other examples). For example, the first device may refrain from receiving a data channel communication, transmitting a data channel communication, receiving one or more signals, transmitting one or more signals, and/or transmitting a report using resources that are outside of a window of time from a control channel monitoring occasion.

In some aspects, the data may be scheduled via a dynamic grant (e.g., using downlink control information (DCI)) and/or a configured grant (e.g., a downlink SPS grant or an uplink configured grant, among other examples). In some aspects, a value of the threshold may be indicated to the first device by a second device (e.g., a network node) via, for example, a radio resource control (RRC) message or one or more medium access control (MAC) control elements (MAC CEs).

In some aspects, the first device may indicate (e.g., via UE capability reporting), to the second device, capabilities of the first device to support selectively receiving a communication based at least in part on timing of a resource allocation relative to a closest periodic communication. In some aspects, the first device may indicate, to the second device, preferred values of the threshold via, for example, UE assistance information feedback.

In some aspects, the threshold may be in a communication protocol-based time unit. For example, the threshold may be a number of symbols or slots. If using a number of symbols for the communication protocol-based time unit, a value may be zero, indicating that the UE is to receive or transmit a data channel communication based at least in part on the data channel communication being scheduled within a same slot as a control channel monitoring occasion.

In some aspects, the threshold and/or a distance between the data channel communication and the control channel monitoring occasion may be measured from an end of a previous closest monitoring occasion and/or a start of the next closest monitoring occasion.

Based at least in part on the threshold not being satisfied based at least in part on scheduling information of the data channel, the first device may refrain from receiving or transmitting a communication via the data channel. In this way, the first device may conserve power resource based at least in part on decreasing an amount of time spent in the wake up mode (e.g., an active communication mode). Additionally, or alternatively, ramping up and ramping down also consumes power, and refraining from receiving communications that are outside of the threshold time may reduce a number of times that the first device ramps up and ramps down (e.g., in a period of time), which conserves power resources of the first device. Additionally, or alternatively, two reception occasions (e.g., a first reception occasion and a second reception occasion) that are close to each other, (e.g., within the threshold time) have improved power efficiency based at least in part on the first device remaining in the wake-up mode, instead of ramping down to the sleep mode after the first reception occasion and then ramping back up to the wake-up mode before the second reception occasion. In some aspects, additional power to receive the second reception by remaining in the wake-up mode may be only marginally greater than reception during the first reception occasion alone.

However, if the two reception occasions are far apart in time (e.g., outside of the threshold amount of time), based at least in part on the first device remaining in the wake-up mode, power consumption (e.g., shown by reference number 315 in FIG. 3) is higher than the sleep power (e.g., shown by reference number 320 in FIG. 3). Therefore, in this case, the first device may go back to sleep and wake up again, which also requires very high power consumption compared to the above example where the two reception occasions are within the threshold time.

If a data channel is a downlink data channel (e.g., PDSCH) and the first device refrains from receiving (e.g., drops) the data channel communication based on failing to satisfy the threshold, the first device may be configured to provide hybrid automatic repeat request (HARD) acknowledgment (HARQ-ACK) feedback or to refrain from providing HARQ-ACK feedback. For example, the first device may be configured to always provide a negative acknowledgment (NACK) (e.g., based at least in part on being configured with a Type-1 HARQ-ACK codebook that has a static size). Additionally, or alternatively, the first device may be configured not to report the HARQ-ACK feedback or to exclude the HARQ-ACK feedback from a HARQ-ACK codebook (e.g., based at least in part on being configured with a Type-2 HARQ-ACK codebook having a dynamic size).

In addition to a control channel (e.g., PDCCH or PSCCH), the techniques described may be extended for other channels or signals. For example, the first device may not expect that a data channel and/or a signal is scheduled at a distance (e.g., in time) that is outside of the threshold from a nearest periodic and/or SPS-based CSI-RS occasion. For example, with an uplink data communication, the first device may not expect to be scheduled to transmit a data channel communication at a distance that is outside of the threshold from a nearest control channel occasion for periodic and/or semi-persistent CSI reporting resource (e.g., a configured resource or a dynamically scheduled resource).

In some aspects, different channel types and/or different signal types may have different values of the threshold. For example, a first value may be indicated and/or configured for control channel to data channel distances, a second value may be indicated and/or configured for periodic CSI-RS to data channel distances, a third value may be indicated and/or configured for periodic CSI reporting to data channel distances, etc.

In some aspects, a first time-domain resource allocation (TDRA) table may be configured for the data channel and/or a second CSI-RS or SRS triggering offset may be used when the UE is in the power efficiency mode (e.g., a power default SSSG or in a power saving operation mode, among other examples). In some aspects (e.g., in an NR communication protocol), a configuration of a TDRA table may be based at least in part on a bandwidth part (BWP). For example, an RRC message (e.g., pdsch-Config) may configure a table of TDRA values (e.g., pdsch-TimeDomainAllocationList) for different bandwidth parts and/or for the power efficiency mode. In some aspects, a dedicated TDRA table or set of aperiodic CSI-RS or SRS trigger offset values for the power efficiency mode (e.g., default SSSG or power saving mode) may be used to compensate for a loss of flexibility to schedule outside of the threshold.

Based at least in part on the first device being configured to selectively receive the communication based at least in part on whether the resource allocation has resources within a threshold amount of time from a closest periodic communication of the one or more periodic communications, the first device may conserve power resources that may have otherwise been used to wake up for communications that are scheduled outside of the threshold amount of time from the closest periodic communication.

FIG. 4 is a diagram illustrating an example associated with techniques for selectively receiving a communication based at least in part on timing of a resource allocation relative to a closest periodic communication, in accordance with the present disclosure. As shown in FIG. 4, a network node (e.g., network node 110) may communicate with a UE (e.g., UE 120). In some aspects, the network node and the UE may be part of a wireless network (e.g., wireless network 100). The UE and the network node may have established a wireless connection prior to operations shown in FIG. 4. Although FIG. 4 is described in the context of communications between a UE and a network node, the techniques described herein may be applied to communications between any first device and any second device, such as a first UE and a second UE in a sidelink communication or a devices in an industrial Internet of Things environment.

As shown by reference number 405, the network node may transmit, and the UE may receive, configuration information. In some aspects, the UE may receive the configuration information via one or more of RRC signaling, MAC CEs, or DCI, among other examples. In some aspects, the configuration information may include an indication of one or more configuration parameters (e.g., already known to the UE) for selection by the UE, or explicit configuration information for the UE to use to configure the UE, among other examples.

In some aspects, the configuration information may indicate that the UE is to determine whether to receive or transmit a communication based at least in part on timing of the communication (e.g., timing or resources allocated for the communication) relative to a periodic communication. In some aspects, the configuration information may indicate that the UE is to determine whether to receive or transmit a communication based at least in part on timing of the communication relative to the periodic communication when in a power efficiency mode. In some aspects, the configuration information may indicate one or more parameters for selectively transmitting or receiving communications based at least in part on the timing of the communication relative to the periodic communication.

The UE may configure itself based at least in part on the configuration information. In some aspects, the UE may be configured to perform one or more operations described herein based at least in part on the configuration information.

As shown by reference number 410, the UE may transmit, and the network node may receive, an indication of support for selection of a set of control channel monitoring skip durations for later selection of a control channel monitoring skip duration. For example, the UE may transmit an indication of a capability to (e.g., support for) selectively receive or refrain from receiving the communication based at least in part on the timing of the resource allocation relative to the closest periodic communication. In some aspects, the UE may transmit an indication of an amount of power used to ramp up for a wake up time and/or to ramp down from a wake up time (e.g., to provide information for evaluating timing of communications for power saving).

As shown by reference number 415, the UE may transmit, and the network node may receive, an indication of a requested configuration for selectively receiving a communication and/or information for selection of the configuration. In some aspects, the UE may transmit the indication of the requested configuration and/or information for selection of the configuration via MAC signaling and/or RRC signaling.

In some aspects, the UE may transmit the indication of the requested configuration based at least in part on a power setting and/or power configuration at the UE. In some aspects, the UE may transmit the indication of the requested configuration based at least in part on an amount of power and/or an amount of time consumed by the UE to ramp up or ramp down from a wake up time. In some aspects, the UE may transmit the information for selection of the configuration including, for example, an indication of the power setting, the power configuration at the UE, and/or an amount of power and/or an amount of time consumed by the UE to ramp up or ramp down from a wake up time, among other examples.

As shown by reference number 420, the UE may receive, and the network node may transmit, an indication of a configuration for selectively receiving a communication. In some aspects, the UE may receive the indication of the configuration via RRC signaling (e.g., a configuration message and/or a configured grant, among other examples) and/or MAC signaling.

In some aspects, the configuration for selectively receiving the communication may indicate a threshold amount of time, from a closest periodic communication, at which the UE is to refrain from receiving a communication. For example, the configuration may indicate that the UE is to receive the communication based at least in part on the resource allocation having resources within a threshold amount of time from a closest periodic communication of the one or more periodic communications, or refrain from receiving the communication based at least in part on the resource allocation having resources outside of the threshold amount of time from the closest periodic communication of the one or more periodic communications. In some aspects, the configuration may indicate that the UE is to refrain from receiving the communication based at least in part on the UE operating in a power efficiency mode associated with communicating using periodic communications having a periodicity that satisfies a threshold.

In some aspects, the threshold (e.g., the threshold amount of time) may be based at least in part on a communication protocol-based time unit, such as an integer number of slots or an integer number of symbols, among other examples. In some aspects, the threshold may be zero (e.g., zero slots), which may indicate to receive the communication based at least in part on the resource allocation identifying resources within a same communication protocol-based time unit (e.g., a same slot).

In some aspects, the threshold amount of time may be measured from an end of a closest periodic communication that is prior to the resource allocation and/or from a beginning of a closest periodic communication that is after the resource allocation. For example, the threshold amount of time may be measured to only a closest prior periodic communication, only a closest later periodic communication, or a closest of prior periodic communications and later periodic communications.

In some aspects, the threshold amount of time may be different based at least in part on a type of the communication or the one or more periodic communications. For example, data channels may have a different threshold amount of time from control channels, reference signals, and/or reporting signals. Uplink communications may have a different threshold amount of time from downlink communications. In some aspects, the threshold amount of time may be based at least in part on a channel type associated with at least one of the resource allocation for the communication or the configuration of the one or more periodic communications, a reference signal type associated with at least one of the resource allocation for the communication or the configuration of the one or more periodic communications, and/or a report type associated with at least one of the resource allocation for the communication or the configuration of the one or more periodic communications. In some aspects, the indication of the configuration may indicate each of the different threshold amounts of time and/or indicate a set of different threshold amounts of time already known to the UE.

In some aspects, the configuration may indicate a TDRA table for the resource allocation for the communication that is associated with the power efficiency mode of the UE. In some aspects, the TDRA table that is associated with the power efficiency mode of the UE is configured to include candidate resources that are configured for scheduling within the threshold amount of time from the closest periodic communication of the one or more periodic communications. In some aspects, the configuration may indicate a set of candidate CSI-RS or SRS triggering offsets, for the resource allocation for the communication, that is associated with the power efficiency mode of the UE. In some aspects, the set of candidate CSI-RS or SRS triggering offsets that is associated with the power efficiency mode of the UE is configured to include candidate CSI-RS or SRS triggering offsets that are configured for scheduling within the threshold amount of time from the closest periodic communication of the one or more periodic communications.

In some aspects, the configuration may indicate that the UE is to refrain from transmitting HARQ-ACK feedback for communications based at least in part on an associated resource allocation having resources outside of the threshold amount of time. In some aspects, the configuration may indicate that the UE is to refrain from transmitting the HARQ-ACK feedback based at least in part on the UE being configured with a HARQ-ACK codebook having a dynamic size (e.g., a Type 2 HARQ-ACK codebook). In some aspects, the configuration may indicate that the UE is to transmit HARQ-ACK feedback for communications based at least in part on an associated resource allocation having resources outside of the threshold amount of time (e.g., and the UE refraining from receiving the communication). In some aspects, the configuration may indicate that the UE is to transmit the HARQ-ACK feedback based at least in part on the UE being configured with a HARQ-ACK codebook having a static and/or fixed size (e.g., a Type 1 HARQ-ACK codebook).

As shown by reference number 425, the UE may receive, and the network node may transmit, a configuration (e.g., an indication of a configuration) of one or more periodic communications. In some aspects, the one or more periodic communications may be scheduled via a configured grant. In some aspects, the one or more periodic communications may include periodic control channel communications or one or more SPS-based control channel communications, among other examples. In some aspects, the one or more periodic communications include one or more periodic reference signal reception occasions, one or more SPS-based reference signal reception occasions, one or more periodic channel state information reporting occasions, and/or one or more SPS-based channel state information reporting occasions, among other examples.

As shown by reference number 430, the UE may receive, and the network node may transmit, an indication of a resource allocation for a communication. In some aspects, the UE may receive the resource allocation via a dynamic grant (e.g., via DCI and/or MAC signaling, among other examples) or via a configured grant (e.g., RRC signaling), among other examples. In some aspects, the communication may be associated with a downlink data channel, an uplink data channel, or a sidelink data channel. In some aspects, the communication may be associated with an aperiodic downlink reference signal, an aperiodic uplink reference signal, or an aperiodic sidelink reference signal, among other examples.

In some aspects, the UE may apply a TDRA table, for the resource allocation for the communication, that is associated with a power efficiency mode of the UE. In some aspects, the UE may apply a set of candidate CSI signal triggering offsets, for the resource allocation for the communication, that is associated with a power efficiency mode of the UE.

As shown by reference number 435, the UE may determine whether to receive or transmit the communication. For example, the UE may determine whether to receive the communication based at least in part on whether the resource allocation has resources within a threshold amount of time from a closest periodic communication of the one or more periodic communications. For example, the UE may determine to receive the communication based at least in part on the resource allocation having resources within a threshold amount of time from a closest periodic communication of the one or more periodic communications. Alternatively, the UE may determine to refrain from receiving the communication based at least in part on the resource allocation having resources outside of the threshold amount of time from the closest periodic communication of the one or more periodic communications.

As shown by reference number 440, the UE may refrain from receiving or transmitting the communication based at least in part on timing (e.g., of the communication) relative to a closest periodic communication. For example, the UE may refrain from receiving or transmitting the communication based at least in part on a determination to receive or transmit the communication, as described in connection with reference number 435 (e.g., based at least in part on the resource allocation having resources outside of the threshold amount of time from the closest periodic communication of the one or more periodic communications). Additionally, or alternatively, the UE may refrain from receiving the communication further based at least in part on the UE operating in a power efficiency mode associated with communicating using periodic communications having a periodicity that satisfies a threshold.

As shown by reference number 445, the UE may receive or transmit, and the network node may transmit or receive, the communication based at least in part on timing relative to the closest periodic communication. For example, the UE may receive or transmit the communication based at least in part on a determination to receive or transmit the communication, as described in connection with reference number 435. The UE may receive or transmit the communication as an alternative to refraining from receiving or transmitting the communication, as described in connection with reference number 440. In some aspects, the UE may enter a wake up mode only to receive the communication (e.g., if a periodic communication is skipped). Alternatively, the UE may enter a wake up mode to receive the communication in addition to another communication (e.g., a periodic communication).

As shown by reference number 450, the UE may determine whether to transmit a NACK for the communication. For example, the UE may determine whether to transmit the NACK after refraining from receiving the communication based at least in part on timing relative to the closest periodic communication.

In some aspects, the UE may determine to transmit a NACK for the communication based at least in part on refraining from receiving the communication (e.g., based at least in part on the resource allocation having resources outside of the threshold amount of time). In some aspects, the UE may determine to transmit the NACK for the communication based at least in part on being configured with a HARQ-ACK codebook having a fixed size.

In some aspects, the UE may determine to refrain from transmitting HARQ-ACK feedback for the communication based at least in part on refraining from receiving the communication (e.g., based at least in part on the resource allocation having resources outside of the threshold amount of time). In some aspects, the UE may determine to refrain from transmitting the HARQ-ACK feedback based at least in part on being configured with a HARQ-ACK codebook having a dynamic size.

As shown by reference number 455, the UE may transmit, and the network node may receive, the NACK. For example, the UE may transmit the NACK based at least in part on a determination to transmit the NACK for the communication, as described in connection with reference number 450. Alternatively, the UE may refrain from transmitting the NACK based at least in part on a determination to refrain from transmitting the NACK for the communication, as described in connection with reference number 450.

Based at least in part on the UE being configured to selectively receive the communication based at least in part on whether the resource allocation has resources within a threshold amount of time from a closest periodic communication of the one or more periodic communications, the UE may conserve power resources that may have otherwise been used to wake up for communications that are scheduled outside of the threshold amount of time from the closest periodic communication.

As indicated above, FIG. 4 is provided as an example. Other examples may differ from what is described with regard to FIG. 4.

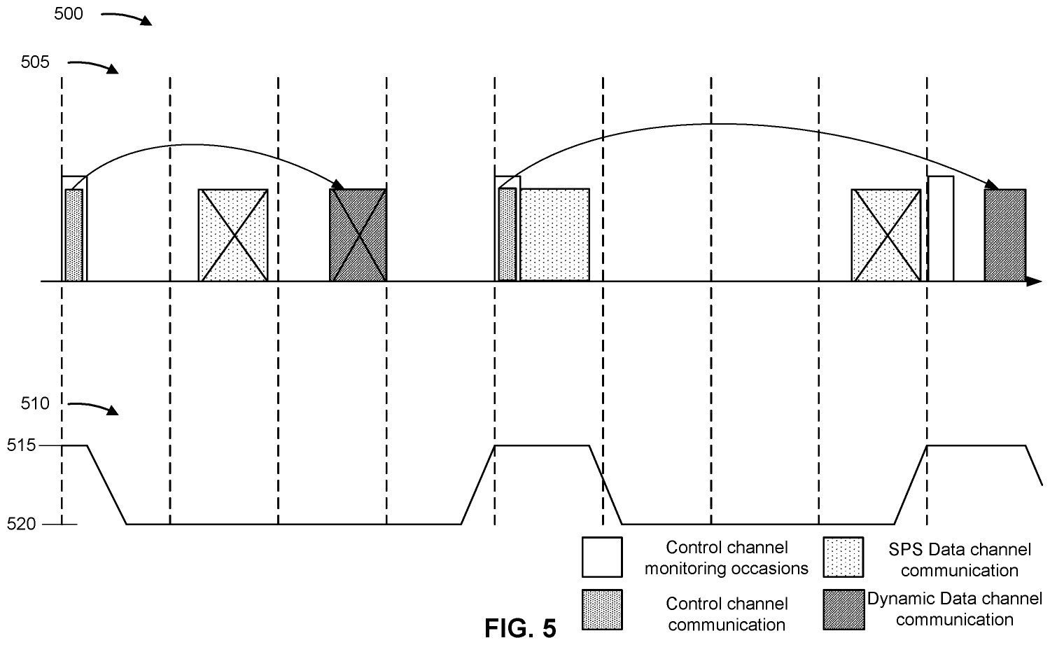

FIG. 5 is a diagram illustrating an example associated with techniques for selectively receiving a communication based at least in part on timing of a resource allocation relative to a closest periodic communication, in accordance with the present disclosure. As shown in FIG. 4, a first device (e.g., UE 120) may communicate with a second device (e.g., network node 110). In some aspects, the first device and the second device may be part of a wireless network (e.g., wireless network 100). The first device and the second device may have established a wireless connection prior to operations shown in FIG. 5. The techniques described herein may be applied to communications between any first device and any second device, such as a first UE and a second UE in a sidelink communication or a devices in an industrial Internet of Things environment.

The first device may be configured with a set of control channel monitoring occasions (e.g., PDCCH monitoring occasions or PSCCH monitoring occasions) during which the first device is to monitor for a control channel communication. For example, the first device may be configured with the set of control channel monitoring occasions based at least in part on the first device being in a power saving mode, such as a DRX mode.

To conserve power, the first device may be in a power efficiency mode in which the first device is configured to wake up for control channel monitoring occasions with an increased period length than in a standard power efficiency mode. For example, as shown in by reference number 505, the first device may be configured with a control channel monitoring occasion every fourth slot.

The first device may receive a control channel communication, within a control channel monitoring occasion, that schedules a dynamic data channel communication. Additionally, or alternatively, the first device may be configured with an SPS-based data channel communication.

As shown by reference number 510, the first device may consume different amounts of power resources based at least in part on whether the first device is in a wake-up time or a sleep time. For example, the first device may consume a first amount of power, shown by reference number 515, when in a wake up time and may consume a second amount of power, shown by reference number 520, when in a sleep time. Additionally, or alternatively, the first device may consume power in a ramp up time preceding a wake up time and in a ramp down time after the wake up time.

As shown in example 500, the first device may be configured to receive data channel communications only when they are within a threshold amount of time from a control channel monitoring occasion. The first device may be configured to refrain from receiving data channel communications when they are outside of the threshold amount of time from a control channel monitoring occasion.

In the example 500, the first device receives a control channel communication during a first control channel monitoring occasion in a first slot. The control channel communication dynamically schedules a data channel communication in a third slot. The first device may be configured with a threshold amount of time as zero slots (e.g., the data channel must be received in a same slot as the control channel monitoring occasion). The first device refrains from receiving (e.g., or monitoring for) an SPS-based data channel communication scheduled for a second slot because it is not in a same slot as a control channel monitoring occasion. The first device also refrains from receiving (e.g., or monitoring for) the dynamic data channel communication scheduled for the third second slot because it is not in a same slot as a control channel monitoring occasion.

The first device receives (e.g., monitors for) an SPS-based data channel communication scheduled for a fifth slot because it is in a same slot as a control channel monitoring occasion. The first device refrains from receiving (e.g., or monitoring for) an SPS-based data channel communication scheduled for an eighth slot because it is not in a same slot as a control channel monitoring occasion. The first device receives (e.g., monitors for) a dynamic data channel communication scheduled for a ninth slot because it is in a same slot as a control channel monitoring occasion.

As shown by reference number 510, the first device conserved power resources relative to a power saving mode in which the first device wakes up for each scheduled data channel communication (e.g., as shown in FIG. 3).

As indicated above, FIG. 5 is provided as an example. Other examples may differ from what is described with regard to FIG. 5.

FIG. 6 is a diagram illustrating an example process 600 performed, for example, by a UE, in accordance with the present disclosure. Example process 600 is an example where the UE (e.g., UE 120) performs operations associated with techniques for selectively receiving a communication based at least in part on timing of a resource allocation relative to a closest periodic communication.

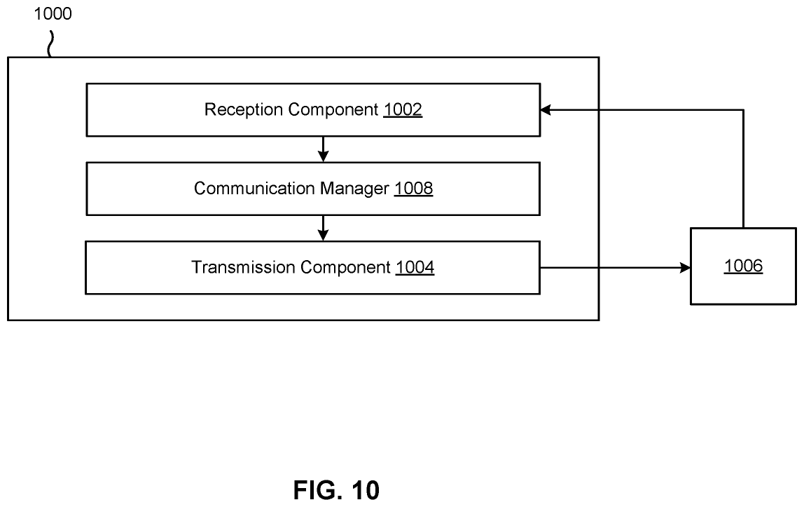

As shown in FIG. 6, in some aspects, process 600 may include receiving a configuration of one or more periodic communications (block 610). For example, the UE (e.g., using communication manager 140 and/or reception component 1002, depicted in FIG. 10) may receive a configuration of one or more periodic communications, as described above.

As further shown in FIG. 6, in some aspects, process 600 may include receiving an indication of a resource allocation for a communication (block 620). For example, the UE (e.g., using communication manager 140 and/or reception component 1002, depicted in FIG. 10) may receive an indication of a resource allocation for a communication, as described above.

As further shown in FIG. 6, in some aspects, process 600 may include determining whether to receive the communication based at least in part on whether the resource allocation has resources within a threshold amount of time from a closest periodic communication of the one or more periodic communications (block 630). For example, the UE (e.g., using communication manager 140 and/or communication manager 1008, depicted in FIG. 10) may determine whether to receive the communication based at least in part on whether the resource allocation has resources within a threshold amount of time from a closest periodic communication of the one or more periodic communications, as described above.

Process 600 may include additional aspects, such as any single aspect or any combination of aspects described below and/or in connection with one or more other processes described elsewhere herein.

In a first aspect, process 600 includes refraining from receiving the communication based at least in part on the resource allocation having resources outside of the threshold amount of time from the closest periodic communication of the one or more periodic communications.

In a second aspect, alone or in combination with the first aspect, the refraining from receiving the communication is further based at least in part on the UE operating in a power efficiency mode associated with communicating using periodic communications having a periodicity that satisfies a threshold.

In a third aspect, alone or in combination with one or more of the first and second aspects, process 600 includes receiving the communication based at least in part on the resource allocation having resources within the threshold amount of time from the closest periodic communication of the one or more periodic communications.

In a fourth aspect, alone or in combination with one or more of the first through third aspects, the communication is associated with a downlink data channel, the communication is associated with an uplink data channel, the communication is associated with a sidelink data channel, the communication is associated with an aperiodic downlink reference signal, the communication is associated with an aperiodic uplink reference signal, or the communication is associated with an aperiodic sidelink reference signal.

In a fifth aspect, alone or in combination with one or more of the first through fourth aspects, the reception of the indication of the resource allocation for the communication comprises receiving a dynamic grant that includes the indication of the resource allocation, or receiving a configured grant that includes the indication of the resource allocation.

In a sixth aspect, alone or in combination with one or more of the first through fifth aspects, process 600 includes receiving an indication of the threshold amount of time.

In a seventh aspect, alone or in combination with one or more of the first through sixth aspects, the reception of the indication of the threshold amount of time comprises receiving the indication of the threshold amount of time via radio resource control signaling, or receiving the indication of the threshold amount of time via medium access control signaling.

In an eighth aspect, alone or in combination with one or more of the first through seventh aspects, process 600 includes one or more of transmitting an indication of a capability to selectively receive or refrain from receiving the communication based at least in part on the timing of the resource allocation relative to the closest periodic communication, transmitting information associated with selection of the threshold amount of time, or transmitting an indication of a requested threshold amount of time.

In a ninth aspect, alone or in combination with one or more of the first through eighth aspects, the threshold amount of time is based at least in part on one or more of an integer number of slots, or an integer number of symbols.

In a tenth aspect, alone or in combination with one or more of the first through ninth aspects, the threshold amount of time indicates to receive the communication based at least in part on the resource allocation identifying resources within a same communication protocol-based time unit.

In an eleventh aspect, alone or in combination with one or more of the first through tenth aspects, the threshold amount of time is measured from an end of a closest periodic communication that is prior to the resource allocation, or the threshold amount of time is measured from a beginning of a closest periodic communication that is after the resource allocation.

In a twelfth aspect, alone or in combination with one or more of the first through eleventh aspects, process 600 includes transmitting a NACK for the communication based at least in part on refraining from receiving the communication based at least in part on the resource allocation having resources outside of the threshold amount of time.

In a thirteenth aspect, alone or in combination with one or more of the first through twelfth aspects, the transmission of the NACK is based at least in part on being configured with a HARQ-ACK codebook having a fixed size.

In a fourteenth aspect, alone or in combination with one or more of the first through thirteenth aspects, process 600 includes refraining from transmitting HARQ-ACK feedback for the communication based at least in part on refraining from receiving the communication based at least in part on the resource allocation having resources outside of the threshold amount of time.

In a fifteenth aspect, alone or in combination with one or more of the first through fourteenth aspects, the refraining from transmitting the HARQ-ACK feedback is based at least in part on being configured with a HARQ-ACK codebook having a dynamic size.

In a sixteenth aspect, alone or in combination with one or more of the first through fifteenth aspects, the one or more periodic communications comprise one or more periodic control channel communications, one or more semi-persistent scheduling-based control channel communications, one or more periodic reference signal reception occasions, one or more semi-persistent scheduling-based reference signal reception occasions, one or more periodic channel state information reporting occasions, or one or more semi-persistent scheduling-based channel state information reporting occasions.

In a seventeenth aspect, alone or in combination with one or more of the first through sixteenth aspects, the threshold amount of time is based at least in part on one or more of a channel type associated with at least one of the resource allocation for the communication or the configuration of the one or more periodic communications, a reference signal type associated with at least one of the resource allocation for the communication or the configuration of the one or more periodic communications, or a report type associated with at least one of the resource allocation for the communication or the configuration of the one or more periodic communications.

In an eighteenth aspect, alone or in combination with one or more of the first through seventeenth aspects, process 600 includes applying a TDRA table, for the resource allocation for the communication, that is associated with a power efficiency mode of the UE, or applying a set of candidate CSI signal triggering offsets, for the resource allocation for the communication, that is associated with a power efficiency mode of the UE.

In a nineteenth aspect, alone or in combination with one or more of the first through eighteenth aspects, the TDRA table that is associated with the power efficiency mode of the UE is configured to include candidate resources that are configured for scheduling within the threshold amount of time from the closest periodic communication of the one or more periodic communications, or the set of candidate CSI signal triggering offsets that is associated with the power efficiency mode of the UE is configured to include candidate CSI signal triggering offsets that are configured for scheduling within the threshold amount of time from the closest periodic communication of the one or more periodic communications.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a UE, in accordance with the present disclosure. Example process 700 is an example where the UE (e.g., UE 120) performs operations associated with techniques for selectively receiving a communication based at least in part on timing of a resource allocation relative to a closest periodic communication.

As shown in FIG. 7, in some aspects, process 700 may include receiving a configuration of one or more periodic communications (block 710). For example, the UE (e.g., using communication manager 140 and/or reception component 1002, depicted in FIG. 10) may receive a configuration of one or more periodic communications, as described above.

As further shown in FIG. 7, in some aspects, process 700 may include receiving an indication of a resource allocation for a communication (block 720). For example, the UE (e.g., using communication manager 140 and/or reception component 1002, depicted in FIG. 10) may receive an indication of a resource allocation for a communication, as described above.

As further shown in FIG. 7, in some aspects, process 700 may include selectively receiving the communication based at least in part on the resource allocation having resources within a threshold amount of time from a closest periodic communication of the one or more periodic communications, or refraining from receiving the communication based at least in part on the resource allocation having resources outside of the threshold amount of time from the closest periodic communication of the one or more periodic communications (block 730). For example, the UE (e.g., using communication manager 140 and/or communication manager 1008, depicted in FIG. 10) may selectively: receiving the communication based at least in part on the resource allocation having resources within a threshold amount of time from a closest periodic communication of the one or more periodic communications, or refraining from receiving the communication based at least in part on the resource allocation having resources outside of the threshold amount of time from the closest periodic communication of the one or more periodic communications, as described above.

Process 700 may include additional aspects, such as any single aspect or any combination of aspects described below and/or in connection with one or more other processes described elsewhere herein.

In a first aspect, selectively receiving the communication comprises refraining from receiving the communication based at least in part on the resource allocation having resources outside of the threshold amount of time from the closest periodic communication of the one or more periodic communications.

In a second aspect, alone or in combination with the first aspect, selectively receiving the communication comprises receiving the communication based at least in part on the resource allocation having resources within the threshold amount of time from the closest periodic communication of the one or more periodic communications.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a UE, in accordance with the present disclosure. Example process 800 is an example where the UE (e.g., UE 120) performs operations associated with techniques for selectively receiving a communication based at least in part on timing of a resource allocation relative to a closest periodic communication.

As shown in FIG. 8, in some aspects, process 800 may include receiving a configuration of one or more periodic communications (block 810). For example, the UE (e.g., using communication manager 140 and/or reception component 1002, depicted in FIG. 10) may receive a configuration of one or more periodic communications, as described above.

As further shown in FIG. 8, in some aspects, process 800 may include receiving an indication of a resource allocation for a communication (block 820). For example, the UE (e.g., using communication manager 140 and/or reception component 1002, depicted in FIG. 10) may receive an indication of a resource allocation for a communication, as described above.

As further shown in FIG. 8, in some aspects, process 800 may include selectively receiving the communication based at least in part on whether the resource allocation has resources within a threshold amount of time from a closest periodic communication of the one or more periodic communications (block 830). For example, the UE (e.g., using communication manager 140 and/or reception component 1002, depicted in FIG. 10) may selectively receive the communication based at least in part on whether the resource allocation has resources within a threshold amount of time from a closest periodic communication of the one or more periodic communications, as described above.

Process 800 may include additional aspects, such as any single aspect or any combination of aspects described below and/or in connection with one or more other processes described elsewhere herein.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a network node, in accordance with the present disclosure. Example process 900 is an example where the network node (e.g., network node 110) performs operations associated with techniques for selectively receiving a communication based at least in part on timing of a resource allocation relative to a closest periodic communication.

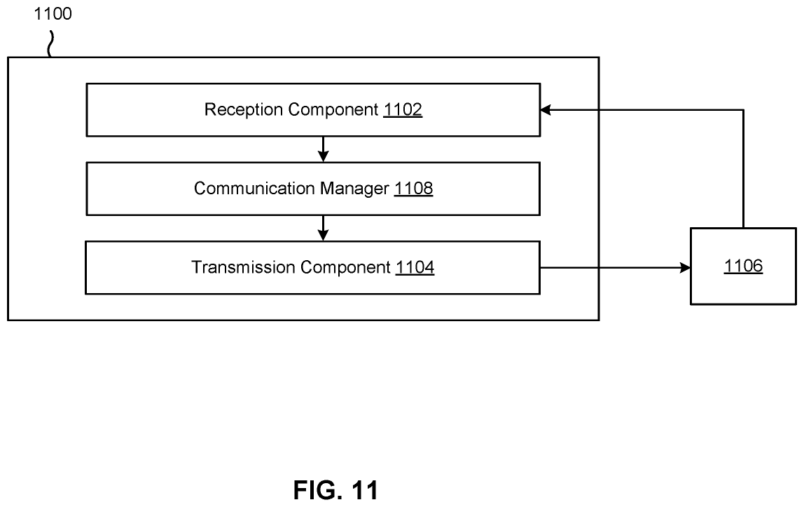

As shown in FIG. 9, in some aspects, process 900 may include transmitting, to a UE, a configuration of one or more periodic communications (block 910). For example, the network node (e.g., using communication manager 150 and/or transmission component 1104, depicted in FIG. 11) may transmit, to a UE, a configuration of one or more periodic communications, as described above.

As further shown in FIG. 9, in some aspects, process 900 may include transmitting, to the UE, an indication of a resource allocation for a communication, the resource allocation having resources within a threshold amount of time from a closest periodic communication of the one or more periodic communications (block 920). For example, the network node (e.g., using communication manager 150 and/or transmission component 1104, depicted in FIG. 11) may transmit, to the UE, an indication of a resource allocation for a communication, the resource allocation having resources within a threshold amount of time from a closest periodic communication of the one or more periodic communications, as described above.

Process 900 may include additional aspects, such as any single aspect or any combination of aspects described below and/or in connection with one or more other processes described elsewhere herein.

In a first aspect, process 900 includes transmitting an indication for the UE to refraining from receiving any communications having resources outside of the threshold amount of time from the closest periodic communication of the one or more periodic communications.

In a second aspect, alone or in combination with the first aspect, the refraining from receiving the communication is further based at least in part on the UE operating in a power efficiency mode associated with communicating using periodic communications having a periodicity that satisfies a threshold.

In a third aspect, alone or in combination with one or more of the first and second aspects, process 900 includes transmitting an indication for the UE to receiving the based at least in part on the resource allocation having resources within the threshold amount of time from the closest periodic communication of the one or more periodic communications.

In a fourth aspect, alone or in combination with one or more of the first through third aspects, the communication is associated with a downlink data channel, the communication is associated with an uplink data channel, the communication is associated with a sidelink data channel, the communication is associated with an aperiodic downlink reference signal, the communication is associated with an aperiodic uplink reference signal, or the communication is associated with an aperiodic sidelink reference signal.

In a fifth aspect, alone or in combination with one or more of the first through fourth aspects, the transmission of the indication of the resource allocation for the communication comprises transmitting a dynamic grant that includes the indication of the resource allocation, or transmitting a configured grant that includes the indication of the resource allocation.

In a sixth aspect, alone or in combination with one or more of the first through fifth aspects, process 900 includes transmitting an indication of the threshold amount of time.

In a seventh aspect, alone or in combination with one or more of the first through sixth aspects, the transmission of the indication of the threshold amount of time comprises transmitting the indication of the threshold amount of time via radio resource control signaling, or transmitting the indication of the threshold amount of time via medium access control signaling.

In an eighth aspect, alone or in combination with one or more of the first through seventh aspects, process 900 includes one or more of receiving an indication of a capability to selectively receive or refrain from receiving the communication based at least in part on the timing of the resource allocation relative to the closest periodic communication, receiving information associated with selection of the threshold amount of time, or receiving an indication of a requested threshold amount of time.

In a ninth aspect, alone or in combination with one or more of the first through eighth aspects, the threshold amount of time is based at least in part on one or more of an integer number of slots, or an integer number of symbols.

In a tenth aspect, alone or in combination with one or more of the first through ninth aspects, the threshold amount of time indicates to receive the communication based at least in part on the resource allocation identifying resources within a same communication protocol-based time unit.

In an eleventh aspect, alone or in combination with one or more of the first through tenth aspects, the threshold amount of time is measured from an end of a closest periodic communication that is prior to the resource allocation, or the threshold amount of time is measured from a beginning of a closest periodic communication that is after the resource allocation.

In a twelfth aspect, alone or in combination with one or more of the first through eleventh aspects, process 900 includes receiving a NACK for the communication based at least in part on the UE refraining from receiving an additional communication based at least in part on an associated additional resource allocation having resources outside of the threshold amount of time.

In a thirteenth aspect, alone or in combination with one or more of the first through twelfth aspects, the reception of the NACK is based at least in part on the UE being configured with a HARQ-ACK codebook having a fixed size.

In a fourteenth aspect, alone or in combination with one or more of the first through thirteenth aspects, process 900 includes transmitting an indication for the UE to refraining from transmitting HARQ-ACK feedback for communications based at least in part on an associated resource allocation having resources outside of the threshold amount of time.

In a fifteenth aspect, alone or in combination with one or more of the first through fourteenth aspects, the indication further indicates to refrain from transmitting the HARQ-ACK feedback based at least in part on the UE being configured with a HARQ-ACK codebook having a dynamic size.

In a sixteenth aspect, alone or in combination with one or more of the first through fifteenth aspects, the one or more periodic communications comprise one or more periodic control channel communications, one or more semi-persistent scheduling-based control channel communications, one or more periodic reference signal reception occasions, one or more semi-persistent scheduling-based reference signal reception occasions, one or more periodic channel state information reporting occasions, or one or more semi-persistent scheduling-based channel state information reporting occasions.

In a seventeenth aspect, alone or in combination with one or more of the first through sixteenth aspects, the threshold amount of time is based at least in part on one or more of a channel type associated with at least one of the resource allocation for the communication or the configuration of the one or more periodic communications, a reference signal type associated with at least one of the resource allocation for the communication or the configuration of the one or more periodic communications, or a report type associated with at least one of the resource allocation for the communication or the configuration of the one or more periodic communications.

In an eighteenth aspect, alone or in combination with one or more of the first through seventeenth aspects, process 900 includes applying a TDRA table, for the resource allocation for the communication, that is associated with a power efficiency mode of the UE, or applying a set of candidate CSI signal triggering offsets, for the resource allocation for the communication, that is associated with a power efficiency mode of the UE.

In a nineteenth aspect, alone or in combination with one or more of the first through eighteenth aspects, the TDRA table that is associated with the power efficiency mode of the UE is configured to include candidate resources that are configured for scheduling within the threshold amount of time from the closest periodic communication of the one or more periodic communications, or the set of candidate CSI signal triggering offsets that is associated with the power efficiency mode of the UE is configured to include candidate CSI signal triggering offsets that are configured for scheduling within the threshold amount of time from the closest periodic communication of the one or more periodic communications.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication. The apparatus 1000 may be a UE, or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a network node, or another wireless communication device) using the reception component 1002 and the transmission component 1004. As further shown, the apparatus 1000 may include a communication manager 1008 (e.g., the communication manager 140). The communication manager 140 may include a determination component, among other examples.

In some aspects, the apparatus 1000 may be configured to perform one or more operations described herein in connection with FIGS. 4-5. Additionally, or alternatively, the apparatus 1000 may be configured to perform one or more processes described herein, such as process 600 of FIG. 6, process 700 of FIG. 7, process 800 of FIG. 8, or a combination thereof. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the UE described in connection with FIG. 2. In some aspects, the transmission component 1004 may be co-located with the reception component 1002 in a transceiver.

The reception component 1002 may receive a configuration of one or more periodic communications. The reception component 1002 may receive an indication of a resource allocation for a communication. The communication manager 1008 may determine whether to receive the communication based at least in part on whether the resource allocation has resources within a threshold amount of time from a closest periodic communication of the one or more periodic communications.

The communication manager 1008 may refrain from receiving the communication based at least in part on the resource allocation having resources outside of the threshold amount of time from the closest periodic communication of the one or more periodic communications.

The reception component 1002 may receive the communication based at least in part on the resource allocation having resources within the threshold amount of time from the closest periodic communication of the one or more periodic communications.

The reception component 1002 may receive an indication of the threshold amount of time.

The transmission component 1004 may transmit a NACK for the communication based at least in part on refraining from receiving the communication based at least in part on the resource allocation having resources outside of the threshold amount of time.

The communication manager 1008 may refrain from transmitting HARQ-ACK feedback for the communication based at least in part on refraining from receiving the communication based at least in part on the resource allocation having resources outside of the threshold amount of time.

The communication manager 1008 may apply a TDRA table, for the resource allocation for the communication, that is associated with a power efficiency mode of the UE.

The communication manager 1008 may apply a set of candidate CSI signal triggering offsets, for the resource allocation for the communication, that is associated with a power efficiency mode of the UE.

The reception component 1002 may receive a configuration of one or more periodic communications. The reception component 1002 may receive an indication of a resource allocation for a communication. The communication manager 1008 may selectively receiving the communication based at least in part on the resource allocation having resources within a threshold amount of time from a closest periodic communication of the one or more periodic communications, or refraining from receiving the communication based at least in part on the resource allocation having resources outside of the threshold amount of time from the closest periodic communication of the one or more periodic communications.

The reception component 1002 may receive a configuration of one or more periodic communications. The reception component 1002 may receive an indication of a resource allocation for a communication. The reception component 1002 may selectively receive the communication based at least in part on whether the resource allocation has resources within a threshold amount of time from a closest periodic communication of the one or more periodic communications.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication. The apparatus 1100 may be a network node, or a network node may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a network node, or another wireless communication device) using the reception component 1102 and the transmission component 1104. As further shown, the apparatus 1100 may include a communication manager 1108 (e.g., the communication manager 150).

In some aspects, the apparatus 1100 may be configured to perform one or more operations described herein in connection with FIGS. 4-5. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the network node described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the network node described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the network node described in connection with FIG. 2. In some aspects, the transmission component 1104 may be co-located with the reception component 1102 in a transceiver.

The transmission component 1104 may transmit, to a UE, a configuration of one or more periodic communications. The transmission component 1104 may transmit, to the UE, an indication of a resource allocation for a communication, the resource allocation having resources within a threshold amount of time from a closest periodic communication of the one or more periodic communications.

The transmission component 1104 may transmit an indication for the UE refrain from receiving any communications having resources outside of the threshold amount of time from the closest periodic communication of the one or more periodic communications.

The transmission component 1104 may transmit an indication for the UE receive the based at least in part on the resource allocation having resources within the threshold amount of time from the closest periodic communication of the one or more periodic communications.

The transmission component 1104 may transmit an indication of the threshold amount of time.

The reception component 1102 may receive a NACK for the communication based at least in part on the UE refraining from receiving an additional communication based at least in part on an associated additional resource allocation having resources outside of the threshold amount of time.

The transmission component 1104 may transmit an indication for the UE refrain from transmitting HARQ-ACK feedback for communications based at least in part on an associated resource allocation having resources outside of the threshold amount of time.

The communication manager 1108 may apply a TDRA table, for the resource allocation for the communication, that is associated with a power efficiency mode of the UE.

The communication manager 1008 may apply a set of candidate CSI signal triggering offsets, for the resource allocation for the communication, that is associated with a power efficiency mode of the UE.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a user equipment (UE), comprising: receiving a configuration of one or more periodic communications; receiving an indication of a resource allocation for a communication; and determining whether to receive the communication based at least in part on whether the resource allocation has resources within a threshold amount of time from a closest periodic communication of the one or more periodic communications.

Aspect 2: The method of Aspect 1, further comprising: refraining from receiving the communication based at least in part on the resource allocation having resources outside of the threshold amount of time from the closest periodic communication of the one or more periodic communications.

Aspect 3: The method of Aspect 2, wherein the refraining from receiving the communication is further based at least in part on the UE operating in a power efficiency mode associated with communicating using periodic communications having a periodicity that satisfies a threshold.

Aspect 4: The method of any of Aspects 1-3, further comprising: receiving the communication based at least in part on the resource allocation having resources within the threshold amount of time from the closest periodic communication of the one or more periodic communications.

Aspect 5: The method of any of Aspects 1-4, wherein the communication is associated with a downlink data channel, wherein the communication is associated with an uplink data channel, wherein the communication is associated with a sidelink data channel, wherein the communication is associated with an aperiodic downlink reference signal, wherein the communication is associated with an aperiodic uplink reference signal, or wherein the communication is associated with an aperiodic sidelink reference signal.

Aspect 6: The method of any of Aspects 1-5, wherein the reception of the indication of the resource allocation for the communication comprises: receiving a dynamic grant that includes the indication of the resource allocation, or receiving a configured grant that includes the indication of the resource allocation.

Aspect 7: The method of any of Aspects 1-6, further comprising: receiving an indication of the threshold amount of time.

Aspect 8: The method of Aspect 7, wherein the reception of the indication of the threshold amount of time comprises: receiving the indication of the threshold amount of time via radio resource control signaling, or receiving the indication of the threshold amount of time via medium access control signaling.

Aspect 9: The method of any of Aspects 1-8, further comprising one or more of: transmitting an indication of a capability to selectively receive or refrain from receiving the communication based at least in part on the timing of the resource allocation relative to the closest periodic communication, transmitting information associated with selection of the threshold amount of time, or transmitting an indication of a requested threshold amount of time.

Aspect 10: The method of any of Aspects 1-9, wherein the threshold amount of time is based at least in part on one or more of: an integer number of slots, or an integer number of symbols.

Aspect 11: The method of any of Aspects 1-10, wherein the threshold amount of time indicates to receive the communication based at least in part on the resource allocation identifying resources within a same communication protocol-based time unit.

Aspect 12: The method of any of Aspects 1-11, wherein the threshold amount of time is measured from an end of a closest periodic communication that is prior to the resource allocation, or wherein the threshold amount of time is measured from a beginning of a closest periodic communication that is after the resource allocation.

Aspect 13: The method of any of Aspects 1-12, further comprising: transmitting a negative acknowledgment (NACK) for the communication based at least in part on refraining from receiving the communication based at least in part on the resource allocation having resources outside of the threshold amount of time.

Aspect 14: The method of Aspect 13, wherein the transmission of the NACK is based at least in part on being configured with a HARQ-ACK codebook having a fixed size.

Aspect 15: The method of any of Aspects 1-14, further comprising: refraining from transmitting hybrid automatic repeat request (HARQ) acknowledgment (HARQ-ACK) feedback for the communication based at least in part on refraining from receiving the communication based at least in part on the resource allocation having resources outside of the threshold amount of time.

Aspect 16: The method of Aspect 15, wherein the refraining from transmitting the HARQ-ACK feedback is based at least in part on being configured with a HARQ-ACK codebook having a dynamic size.

Aspect 17: The method of any of Aspects 1-16, wherein the one or more periodic communications comprise: one or more periodic control channel communications, one or more semi-persistent scheduling-based control channel communications, one or more periodic reference signal reception occasions, one or more semi-persistent scheduling-based reference signal reception occasions, one or more periodic channel state information reporting occasions, or one or more semi-persistent scheduling-based channel state information reporting occasions.

Aspect 18: The method of any of Aspects 1-17, wherein the threshold amount of time is based at least in part on one or more of: a channel type associated with at least one of the resource allocation for the communication or the configuration of the one or more periodic communications, a reference signal type associated with at least one of the resource allocation for the communication or the configuration of the one or more periodic communications, or a report type associated with at least one of the resource allocation for the communication or the configuration of the one or more periodic communications.

Aspect 19: The method of any of Aspects 1-11, further comprising: applying a time-domain resource allocation (TDRA) table, for the resource allocation for the communication, that is associated with a power efficiency mode of the UE, or applying a set of candidate channel state information (CSI) signal triggering offsets, for the resource allocation for the communication, that is associated with a power efficiency mode of the UE.

Aspect 20: The method of Aspect 19, wherein the TDRA table that is associated with the power efficiency mode of the UE is configured to include candidate resources that are configured for scheduling within the threshold amount of time from the closest periodic communication of the one or more periodic communications, or wherein the set of candidate CSI signal triggering offsets that is associated with the power efficiency mode of the UE is configured to include candidate CSI signal triggering offsets that are configured for scheduling within the threshold amount of time from the closest periodic communication of the one or more periodic communications.

Aspect 21: A method of wireless communication performed by a user equipment (UE), comprising: receiving a configuration of one or more periodic communications; receiving an indication of a resource allocation for a communication; and selectively: receiving the communication based at least in part on the resource allocation having resources within a threshold amount of time from a closest periodic communication of the one or more periodic communications, or refraining from receiving the communication based at least in part on the resource allocation having resources outside of the threshold amount of time from the closest periodic communication of the one or more periodic communications.

Aspect 22: A method of wireless communication performed by a user equipment (UE), comprising: receiving a configuration of one or more periodic communications; receiving an indication of a resource allocation for a communication; and selectively receiving the communication based at least in part on whether the resource allocation has resources within a threshold amount of time from a closest periodic communication of the one or more periodic communications.

Aspect 23: The method of Aspect 22, wherein selectively receiving the communication comprises: refraining from receiving the communication based at least in part on the resource allocation having resources outside of the threshold amount of time from the closest periodic communication of the one or more periodic communications.

Aspect 24: The method of Aspect 22, wherein selectively receiving the communication comprises: receiving the communication based at least in part on the resource allocation having resources within the threshold amount of time from the closest periodic communication of the one or more periodic communications.

Aspect 25: A method of wireless communication performed by a network node, comprising: transmitting, to a user equipment (UE), a configuration of one or more periodic communications; transmitting, to the UE, an indication of a resource allocation for a communication, the resource allocation having resources within a threshold amount of time from a closest periodic communication of the one or more periodic communications.

Aspect 26: The method of Aspect 25, further comprising transmitting an indication for the UE to: refrain from receiving any communications having resources outside of the threshold amount of time from the closest periodic communication of the one or more periodic communications.

Aspect 27: The method of any of Aspects 25-26, wherein the refraining from receiving the communication is further based at least in part on the UE operating in a power efficiency mode associated with communicating using periodic communications having a periodicity that satisfies a threshold.

Aspect 28: The method of any of Aspects 25-27, further comprising transmitting an indication for the UE to: receive the based at least in part on the resource allocation having resources within the threshold amount of time from the closest periodic communication of the one or more periodic communications.

Aspect 29: The method of any of Aspects 25-28, wherein the communication is associated with a downlink data channel, wherein the communication is associated with an uplink data channel, wherein the communication is associated with a sidelink data channel, wherein the communication is associated with an aperiodic downlink reference signal, wherein the communication is associated with an aperiodic uplink reference signal, or wherein the communication is associated with an aperiodic sidelink reference signal.

Aspect 30: The method of any of Aspects 25-29, wherein the transmission of the indication of the resource allocation for the communication comprises: transmitting a dynamic grant that includes the indication of the resource allocation, or transmitting a configured grant that includes the indication of the resource allocation.

Aspect 31: The method of any of Aspects 25-30, further comprising: transmitting an indication of the threshold amount of time.

Aspect 32: The method of Aspect 31, wherein the transmission of the indication of the threshold amount of time comprises: transmitting the indication of the threshold amount of time via radio resource control signaling, or transmitting the indication of the threshold amount of time via medium access control signaling.

Aspect 33: The method of any of Aspects 25-32, further comprising one or more of: receiving an indication of a capability to selectively receive or refrain from receiving the communication based at least in part on the timing of the resource allocation relative to the closest periodic communication, receiving information associated with selection of the threshold amount of time, or receiving an indication of a requested threshold amount of time.

Aspect 34: The method of any of Aspects 25-33, wherein the threshold amount of time is based at least in part on one or more of: an integer number of slots, or an integer number of symbols.

Aspect 35: The method of any of Aspects 25-34, wherein the threshold amount of time indicates to receive the communication based at least in part on the resource allocation identifying resources within a same communication protocol-based time unit.

Aspect 36: The method of any of Aspects 25-35, wherein the threshold amount of time is measured from an end of a closest periodic communication that is prior to the resource allocation, or wherein the threshold amount of time is measured from a beginning of a closest periodic communication that is after the resource allocation.

Aspect 37: The method of any of Aspects 25-36, further comprising: receiving a negative acknowledgment (NACK) for the communication based at least in part on the UE refraining from receiving an additional communication based at least in part on an associated additional resource allocation having resources outside of the threshold amount of time.

Aspect 38: The method of Aspect 37, wherein the reception of the NACK is based at least in part on the UE being configured with a HARQ-ACK codebook having a fixed size.

Aspect 39: The method of any of Aspects 25-38, further comprising transmitting an indication for the UE to: refrain from transmitting hybrid automatic repeat request (HARQ) acknowledgment (HARQ-ACK) feedback for communications based at least in part on an associated resource allocation having resources outside of the threshold amount of time.

Aspect 40: The method of Aspect 39, wherein the indication further indicates to refrain from transmitting the HARQ-ACK feedback based at least in part on the UE being configured with a HARQ-ACK codebook having a dynamic size.

Aspect 41: The method of any of Aspects 25-40, wherein the one or more periodic communications comprise: one or more periodic control channel communications, one or more semi-persistent scheduling-based control channel communications, one or more periodic reference signal reception occasions, one or more semi-persistent scheduling-based reference signal reception occasions, one or more periodic channel state information reporting occasions, or one or more semi-persistent scheduling-based channel state information reporting occasions.

Aspect 42: The method of any of Aspects 25-41, wherein the threshold amount of time is based at least in part on one or more of: a channel type associated with at least one of the resource allocation for the communication or the configuration of the one or more periodic communications, a reference signal type associated with at least one of the resource allocation for the communication or the configuration of the one or more periodic communications, or a report type associated with at least one of the resource allocation for the communication or the configuration of the one or more periodic communications.

Aspect 43: The method of any of Aspects 25-42, further comprising: applying a time-domain resource allocation (TDRA) table, for the resource allocation for the communication, that is associated with a power efficiency mode of the UE, or applying a set of candidate channel state information (CSI) signal triggering offsets, for the resource allocation for the communication, that is associated with a power efficiency mode of the UE.

Aspect 44: The method of Aspect 43, wherein the TDRA table that is associated with the power efficiency mode of the UE is configured to include candidate resources that are configured for scheduling within the threshold amount of time from the closest periodic communication of the one or more periodic communications, or wherein the set of candidate CSI signal triggering offsets that is associated with the power efficiency mode of the UE is configured to include candidate CSI signal triggering offsets that are configured for scheduling within the threshold amount of time from the closest periodic communication of the one or more periodic communications.

Aspect 45: An apparatus for wireless communication at a device, comprising a processor; memory coupled with the processor; and instructions stored in the memory and executable by the processor to cause the apparatus to perform the method of one or more of Aspects 1-44.

Aspect 46: A device for wireless communication, comprising a memory and one or more processors coupled to the memory, the one or more processors configured to perform the method of one or more of Aspects 1-44.

Aspect 47: An apparatus for wireless communication, comprising at least one means for performing the method of one or more of Aspects 1-44.

Aspect 48: A non-transitory computer-readable medium storing code for wireless communication, the code comprising instructions executable by a processor to perform the method of one or more of Aspects 1-44.

Aspect 49: A non-transitory computer-readable medium storing a set of instructions for wireless communication, the set of instructions comprising one or more instructions that, when executed by one or more processors of a device, cause the device to perform the method of one or more of Aspects 1-44.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.” As used herein, “satisfying a threshold” may, depending on the context, refer to a value being greater than the threshold, greater than or equal to the threshold, less than the threshold, less than or equal to the threshold, equal to the threshold, or not equal to the threshold, among other examples. As used herein, a phrase referring to “at least one of” a list of items refers to any combination of those items, including single members. As an example, “at least one of: a, b, or c” is intended to cover: a, b, c, a+b, a+c, b+c, and a+b+c.

Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (for example, related items, unrelated items, or a combination of related and unrelated items), and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A also may have B). Further, as used herein, the term “or” is intended to be inclusive when used in a series and may be used interchangeably with “and/or,” unless explicitly stated otherwise (for example, if used in combination with “either” or “only one of”).

The various illustrative logics, logical blocks, modules, circuits and algorithm processes described in connection with the aspects disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Aspects of the subject matter described in this specification also can be implemented as one or more computer programs (such as one or more modules of computer program instructions) encoded on a computer storage media for execution by, or to control the operation of, a data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the media described herein should also be included within the scope of computer-readable media. Additionally, the operations of a method or algorithm may reside as one or any combination or set of codes and instructions on a machine readable medium and computer-readable medium, which may be incorporated into a computer program product.

Various modifications to the aspects described in this disclosure may be readily apparent to those skilled in the art, and the generic principles defined herein may be applied to other aspects without departing from the spirit or scope of this disclosure. Thus, the claims are not intended to be limited to the aspects shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate aspects also can be implemented in combination in a single aspect. Conversely, various features that are described in the context of a single aspect also can be implemented in multiple aspects separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the aspects described should not be understood as requiring such separation in all aspects, and it should be understood that the described program components and systems can generally be integrated together in a single software product or packaged into multiple software products. Additionally, other aspects are within the scope of the following claims. In some cases, the actions recited in the claims can be performed in a different order and still achieve desirable results.

What is claimed is:

1. A method of wireless communication performed by a user equipment (UE), comprising:
receiving a configuration of one or more periodic communications;
receiving an indication of a resource allocation for a communication; and
determining whether to receive the communication based at least in part on whether the resource allocation has resources within a threshold amount of time from a closest periodic communication of the one or more periodic communications.

2. The method of claim 1, further comprising:
refraining from receiving the communication based at least in part on the resource allocation having resources outside of the threshold amount of time from the closest periodic communication of the one or more periodic communications.

3. The method of claim 2, wherein the refraining from receiving the communication is further based at least in part on the UE operating in a power efficiency mode associated with communicating using periodic communications having a periodicity that satisfies a threshold.

4. The method of claim 1, further comprising:
receiving the communication based at least in part on the resource allocation having resources within the threshold amount of time from the closest periodic communication of the one or more periodic communications.

5. The method of claim 1, wherein the communication is associated with a downlink data channel,
wherein the communication is associated with an uplink data channel,
wherein the communication is associated with a sidelink data channel,
wherein the communication is associated with an aperiodic downlink reference signal,
wherein the communication is associated with an aperiodic uplink reference signal, or
wherein the communication is associated with an aperiodic sidelink reference signal.

6. The method of claim 1, wherein the reception of the indication of the resource allocation for the communication comprises:
receiving a dynamic grant that includes the indication of the resource allocation, or
receiving a configured grant that includes the indication of the resource allocation.

7. The method of claim 1, further comprising:
receiving an indication of the threshold amount of time via one or more of radio resource control (RRC) signaling or medium access control (MAC) signaling.

8. The method of claim 1, further comprising one or more of:
transmitting an indication of a capability to selectively receive or refrain from receiving the communication based at least in part on the timing of the resource allocation relative to the closest periodic communication,
transmitting information associated with selection of the threshold amount of time, or
transmitting an indication of a requested threshold amount of time.

9. The method of claim 1, wherein the threshold amount of time indicates to receive the communication based at least in part on the resource allocation identifying resources within a same communication protocol-based time unit.

10. The method of claim 1, further comprising:
transmitting a negative acknowledgment (NACK) for the communication based at least in part on refraining from receiving the communication based at least in part on the resource allocation having resources outside of the threshold amount of time, or
refraining from transmitting hybrid automatic repeat request (HARQ) acknowledgment (HARQ-ACK) feedback for the communication based at least in part on refraining from receiving the communication based at least in part on the resource allocation having resources outside of the threshold amount of time.

11. The method of claim 10, wherein the transmission of the NACK is based at least in part on being configured with a HARQ-ACK codebook having a fixed size, or wherein the refraining from transmitting the HARQ-ACK feedback is based at least in part on being configured with a HARQ-ACK codebook having a dynamic size.

12. The method of claim 1, wherein the one or more periodic communications comprise:
one or more periodic control channel communications,
one or more semi-persistent scheduling-based control channel communications,
one or more periodic reference signal reception occasions,
one or more semi-persistent scheduling-based reference signal reception occasions,
one or more periodic channel state information reporting occasions, or
one or more semi-persistent scheduling-based channel state information reporting occasions.

13. The method of claim 1, wherein the threshold amount of time is based at least in part on one or more of:
a channel type associated with at least one of the resource allocation for the communication or the configuration of the one or more periodic communications,
a reference signal type associated with at least one of the resource allocation for the communication or the configuration of the one or more periodic communications, or
a report type associated with at least one of the resource allocation for the communication or the configuration of the one or more periodic communications.

14. The method of claim 1, further comprising:
applying a time-domain resource allocation (TDRA) table, for the resource allocation for the communication, that is associated with a power efficiency mode of the UE, or
applying a set of candidate channel state information (CSI) signal triggering offsets, for the resource allocation for the communication, that is associated with a power efficiency mode of the UE.

15. The method of claim 14, wherein the TDRA table that is associated with the power efficiency mode of the UE is configured to include candidate resources that are configured for scheduling within the threshold amount of time from the closest periodic communication of the one or more periodic communications, or
wherein the set of candidate CSI signal triggering offsets that is associated with the power efficiency mode of the UE is configured to include candidate CSI signal triggering offsets that are configured for scheduling within the threshold amount of time from the closest periodic communication of the one or more periodic communications.

16. A method of wireless communication performed by a network node, comprising:
transmitting, to a user equipment (UE), a configuration of one or more periodic communications; and
transmitting, to the UE, an indication of a resource allocation for a communication, the resource allocation having resources within a threshold amount of time from a closest periodic communication of the one or more periodic communications.

17. The method of claim 16, further comprising transmitting an indication for the UE to:
refrain from receiving any communications having resources outside of the threshold amount of time from the closest periodic communication of the one or more periodic communications.

18. The method of claim 17, wherein the indication for the UE to refrain from receiving any communication having resources outside of the threshold amount of time from the closest periodic communication of the one or more periodic communications is further based at least in part on the UE operating in a power efficiency mode associated with communicating using periodic communications having a periodicity that satisfies a threshold.

19. The method of claim 16, further comprising transmitting an indication for the UE to:
receive the based at least in part on the resource allocation having resources within the threshold amount of time from the closest periodic communication of the one or more periodic communications.

20. The method of claim 16, wherein the communication is associated with a downlink data channel,
wherein the communication is associated with an uplink data channel,
wherein the communication is associated with a sidelink data channel,
wherein the communication is associated with an aperiodic downlink reference signal,
wherein the communication is associated with an aperiodic uplink reference signal, or
wherein the communication is associated with an aperiodic sidelink reference signal.

21. The method of claim 16, wherein the transmission of the indication of the resource allocation for the communication comprises:
transmitting a dynamic grant that includes the indication of the resource allocation, or
transmitting a configured grant that includes the indication of the resource allocation.

22. The method of claim 16, further comprising one or more of:
receiving an indication of a capability to selectively receive or refrain from receiving the communication based at least in part on the timing of the resource allocation relative to the closest periodic communication,
receiving information associated with selection of the threshold amount of time; or
receiving an indication of a requested threshold amount of time.

23. The method of claim 16, wherein the threshold amount of time indicates to receive the communication based at least in part on the resource allocation identifying resources within a same communication protocol-based time unit.

24. The method of claim 16, further comprising:
receiving a negative acknowledgment (NACK) for the communication based at least in part on the UE refraining from receiving an additional communication based at least in part on an associated additional resource allocation having resources outside of the threshold amount of time.

25. The method of claim 24, wherein the reception of the NACK is based at least in part on the UE being configured with a HARQ-ACK codebook having a fixed size.

26. The method of claim 16, wherein the one or more periodic communications comprise:
one or more periodic control channel communications,
one or more semi-persistent scheduling-based control channel communications,
one or more periodic reference signal reception occasions,
one or more semi-persistent scheduling-based reference signal reception occasions,
one or more periodic channel state information reporting occasions, or
one or more semi-persistent scheduling-based channel state information reporting occasions.

27. The method of claim 16, wherein the threshold amount of time is based at least in part on one or more of:
a channel type associated with at least one of the resource allocation for the communication or the configuration of the one or more periodic communications,
a reference signal type associated with at least one of the resource allocation for the communication or the configuration of the one or more periodic communications, or
a report type associated with at least one of the resource allocation for the communication or the configuration of the one or more periodic communications.

28. The method of claim 16, further comprising:
applying a time-domain resource allocation (TDRA) table, for the resource allocation for the communication, that is associated with a power efficiency mode of the UE, or
applying a set of candidate channel state information (CSI) signal triggering offsets, for the resource allocation for the communication, that is associated with a power efficiency mode of the UE.

29. A user equipment (UE) for wireless communication, comprising:
a memory; and
one or more processors, coupled to the memory, configured to:
receive a configuration of one or more periodic communications;
receive an indication of a resource allocation for a communication; and
determine whether to receive the communication based at least in part on whether the resource allocation has resources within a threshold amount of time from a closest periodic communication of the one or more periodic communications.

30. A network node for wireless communication, comprising:
a memory; and
one or more processors, coupled to the memory, configured to:
transmit, to a user equipment (UE), a configuration of one or more periodic communications; and
transmit, to the UE, an indication of a resource allocation for a communication, the resource allocation having resources within a threshold amount of time from a closest periodic communication of the one or more periodic communications.
